(19) United States
(12) Patent Application Publication
(10) Pub. No.: US 2007/0110097 A1
(43) Pub. Date: May 17, 2007

(54) Wireless communication system, communication method and computer readable medium thereof

(76) Inventor: Chih-Ming Hsieh, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/338,111

(22) Filed: Jan. 24, 2006

(30) Foreign Application Priority Data
Nov. 16, 2005 (TW) 094140349

(51) Int. Cl. H04J 15/00; H04B 1/04; H04Q 7/20

(52) U.S. Cl. 370/464; 455/509; 455/103

(57) ABSTRACT

A wireless communication system, a method and a computer readable medium thereof for maintaining communication in an interference environment are provided. The wireless communication system comprises a selection and distribution device and a terminal device which communicate by a beacon. The beacon comprises a definition of an active period and an inactive period. The method comprises the steps of: the selection and distribution device and the terminal device using a first channel in the active period to communicate initially; and the selection and distribution device using a second channel in the inactive period to communicate with the terminal device if the first channel is interfered.

### CROSS-REFERENCES TO RELATED APPLICATIONS

This application claims priority to Taiwan Patent Application No. 094140349 filed on Nov. 16, 2005.

### BACKGROUND OF THE INVENTION

1. Field of the Invention

The present invention relates to a wireless communication system, a communication method and a computer readable medium thereof. More specifically, it relates to a wireless communication system, a communication method, and a computer readable medium thereof communicating by using an inactive period when a regular communication is interfered.

2. Descriptions of the Related Art

Wireless network is one of necessary communication media in the future. However, noise interferences are frequently occurred in data transmission because it is very easy to have other signals in the same operation environment. This problem not only slows down the transmitting speed, but also results in communication interruptions. Therefore, it is necessary to develop a stable communication for wireless network with interference-free capability so as to enhance the communication quality of the wireless network.

In the conventional wireless communication system, it is common to use an additional device so as to reduce the effects from an interference source. As shown in FIG. 1, the conventional wireless communication system comprises a selection and distribution device 11, a terminal device 15, and a beacon signal generator 13. The beacon signal generator 13 is adjacently disposed to the selection and distribution device 11, and signals from both devices are under the same signal coverage 17. The beacon signal generator 13 regularly transmits a beacon signal 10 which carries channel usage information. The selection and distribution device 11 switches to another communication channel if the selection and distribution device 11 is affected by an interference source 19. The terminal device 15 then switches to the new channel which is used by the selection and distribution device 11 after acquiring the information from the beacon signal 10. Said system requires additional hardware devices (beacon signal generator 13) to be able to operate and merely gives consideration for the communicating situation of the selection and distribution device 11 but the terminal device which is interfered. Therefore, in the prior art, additional elements and extra costs are required. Moreover, the prior art is inapplicable if only the terminal device 15 is interfered.

There are other conventional methods available such as regularly switching channels for the wireless communication system so as to avoid communication interference. Such method does not have to replace conventional hardware dispositions. Every channel used by all of the devices could be selected and controlled simply by controlling software so as to set channel parameters, which are used to regularly switch channels in the wireless communication system. However, such method cannot ensure that all of the devices are interference-free even after the switch of the channels. Besides, all of the devices have to regularly switch channels no matter whether there is any interference in the system. Such operation would reduce the efficiency of the whole network and increase energy dissipation when there is no interference source in the system.

According to the above descriptions, the current wireless communication systems and method for reducing interference effects have problems in higher costs, worse application, and more system energy dissipations, etc. Therefore, a wireless communication system and method without extra hardware devices, saving energy resources, adjusting channels appropriately, and being able to be widely applied in a variety of interfered situations, which is desirable in this field.

### SUMMARY OF THE INVENTION

The primary object of the present invention is to provide a wireless communication system. The wireless communication system communicates via a beacon. The beacon defines an active period and an inactive period. The wireless communication system comprises a terminal device, and a selection and distribution device for initially using a first channel in the active period to communicate with each other. The selection and distribution device communicates with the terminal device by using a second channel in the inactive period when the first channel is interfered.

Another object of the present invention is to provide a selection and distribution device for the wireless communication system described above. The selection and distribution device communicates with a terminal device via a beacon and initially uses a first channel in the active period to communicate with the terminal device. The selection and distribution device communicates with the terminal device by using a second channel in the inactive period when the first channel is interfered.

Yet a further object of the present invention is to provide a terminal device for the wireless communication system described above. The terminal device communicates with a selection and distribution device via a beacon and initially uses a first channel in the active period to communicate with the selection and distribution device. The terminal device sends an SOS signal when the first channel is interfered and the terminal device communicates with the selection and distribution device by using a second channel in the inactive period in response to the SOS signal.

Still a further object of the present invention is to provide a communication method for a wireless communication system. The wireless communication system communicates via a beacon and comprises the steps of: using a first channel in the active period to communicate; determining whether the first channel is interfered; and if so, using a second channel in the inactive period to communicate.

Another object of the present invention is to provide a computer readable medium which stores a computer program to perform said communication method.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating a conventional wireless communication system using an extra device to reduce effects from an interference source;

FIG. 2 is a schematic diagram of the first embodiment of the present invention;

FIG. 3 is a schematic diagram of a beacon;

FIG. 4 is a schematic diagram of the second embodiment of the present invention;

FIG. 5 is a flow chart of the third embodiment of the present invention; and

FIG. 6 is a flow chart of the fourth embodiment of the present invention.

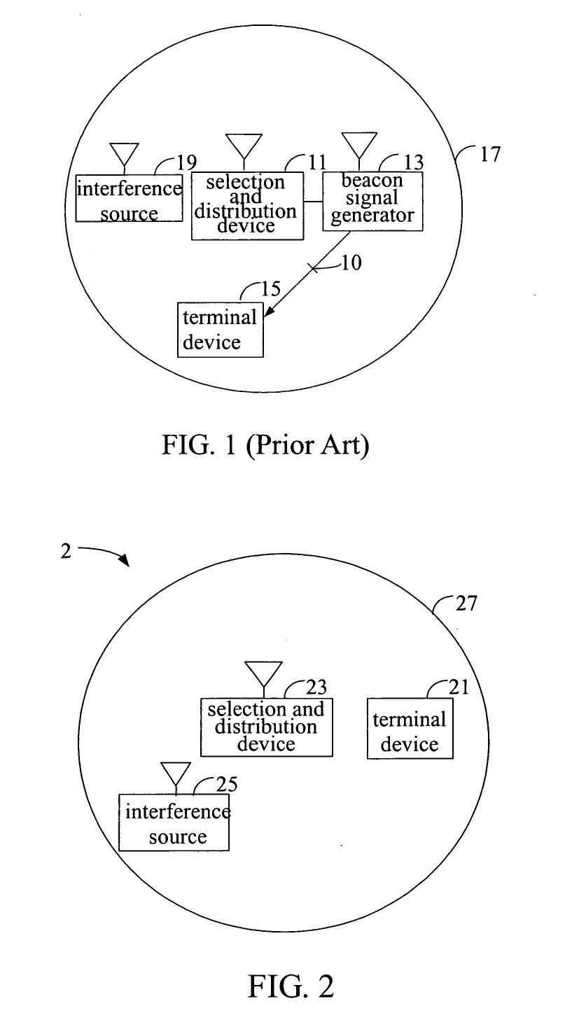

### DESCRIPTION OF THE PREFERRED EMBODIMENT

A wireless communication system 2 in the first embodiment of the present invention is shown in FIG. 2. The wireless communication system 2 comprises a terminal device 21 and a selection and distribution device 23 that communicate with each other via a beacon. An interference source 25 also exists in the wireless communication environment 27 of the wireless communication system 2. A general beacon is illustrated in FIG. 3. A beacon 3 comprises an active period 31 and an inactive period 33. The active period 31 is for transmitting data and the inactive period 33 is a suspension period for data transmission. In other words, the inactive period 33 is not used for data transmission. The selection and distribution device 23 initially uses a first channel in the active period to communicate with the terminal device 21. When the interference source 25 interferes with one of the terminal device 21 and the selection and distribution device 23, the selection and distribution device 23 would determine whether the continuing use of the first channel will be interfered. Therefore, the selection and distribution device 23 will use a second channel in the inactive period 33 to communicate with the terminal device 21 wherein the second channel could be any available channel for the wireless communication system 2 other than the first channel. In this embodiment, the selection and distribution device 23 could be a router or a coordinator.

More particularly, the selection and distribution device 23 and the terminal device 21 use the first channel to transmit data when the selection and distribution device 23 using the first channel to communicate with the terminal device 21 without any interference from the interference source 25. However, if the communication is interfered, the selection and distribution device 23 and the terminal device 21 further use the second channel in the inactive period 33 to transmit same date in addition to the first channel in the active period 31. The communication could be maintained because the second channel is not interfered by the interference source 25.

When the selection and distribution device 23 uses the second channel in the inactive period 33 to communicate with the terminal device 21 and if the terminal device 21 responds availability for using the second channel to communicate, the selection and distribution device 23 could choose continuingly using both the first channel in the active period 31 and the second channel in the inactive period 33 to communicate, or only using the second channel in the active period 31 to communicate while the inactive period 33 restores to not transmitting data.

In this embodiment, the selection and distribution device 23 determines whether the use of the first channel will be interfered, including by receiving an SOS signal from the terminal device. More specifically, the terminal device 21 evaluates the channel quality when the selection and distribution device 23 merely uses the first channel to communicate with the terminal device 21 initially. If the channel quality is inferior, the terminal device 21 sends an SOS signal to the selection and distribution device 23. When the selection and distribution device 23 receives the SOS signal, the interference in the first channel will be confirmed and the second channel in the inactive period could be used to communicate.

In this embodiment, the selection and distribution device 23 determines whether the use of the first channel to communicate is interfered, further including by the failure in communicating with the terminal device 21 via the first channel for N times. In a normal communication, the terminal device 21 sends a determining signal to the selection and distribution device 23 after receiving a beacon 3. When the first channel is interfered, the selection and distribution device 23 could not receive the determining signal. The selection and distribution device 23 determines that the first channel is interfered after the failure of in receiving the determining signal for N times. Then, the second channel in the inactive period is used to communicate. Likewise, when the first channel is interfered, the terminal device 21 tries to communicate for N times. If the beacon 3 can not be received for N times, the terminal device 21 sends an SOS signal to the selection and distribution device 23 informing that the first channel is interfered. Time for waiting to receive the beacon 3 is extended and trial times is reset, so as to continue trying to receive the beacon 3 if the beacon 3 is still not received after the terminal device sent the SOS signal. N is predetermined in the above descriptions.

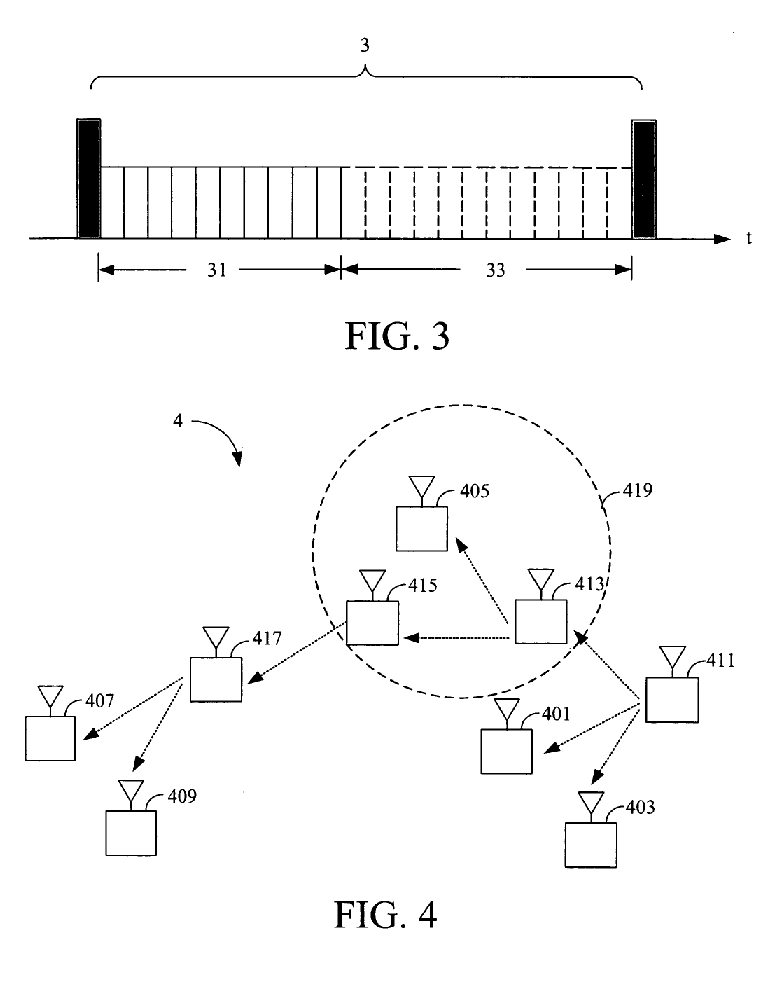

The second embodiment, a wireless communication system as well, of the present invention is shown in FIG. 4. The difference to the first embodiment is that a wireless communication system 4 comprises five terminal devices and four selection and distribution devices wherein five terminal devices are a first terminal device 401, a second terminal device 403, a third terminal device 405, a fourth terminal device 407, and a fifth terminal device 409; four selection and distribution devices are a coordinator 411, a first router 413, a second router 415 and a third router 417. The wireless communication system 4 communicates via a beacon as well. The beacon also defines an active period and an inactive period. The coordinator 411, first router 413, second router 415, third router 417, and the first, second, third, and fourth terminal devices 401, 403, 405, and 407 initially communicate via a first channel in the active period. The communication in the first router 413, second router 415 and the third terminal device 405 under the interference source effect coverage 419, would be affected when they are affected by an interference source (not shown in the figure). Not only the first router 413, and second router 415 respectively communicate with the third terminal device 405 via the second channel in the inactive period, but also the coordinator 411 communicates with the first router 413 and the second router 415 communicates with the third router 417 via the second channel in the inactive period. The first terminal device 401, second terminal device 403, fourth terminal device 407 and fifth terminal device 409 that are not affected by the interference source still merely communicate via the first channel in the active period.

For example, the coordinator 411 needs to transmit data to the fourth terminal device 407, then the coordinator 411 transmits the data to the first router 413 via the first channel in the active period and also via the second channel in the inactive period. The first router 413 transmits the data to the second router 415 via the first channel in the active period and also via the second channel in the inactive period. The second router 415 transmits the data to the third router 417 via the first channel in the active period and also via the second channel in the inactive period. The third router 417 transmits the data to the fourth terminal device 407 via the first channel in the active period.

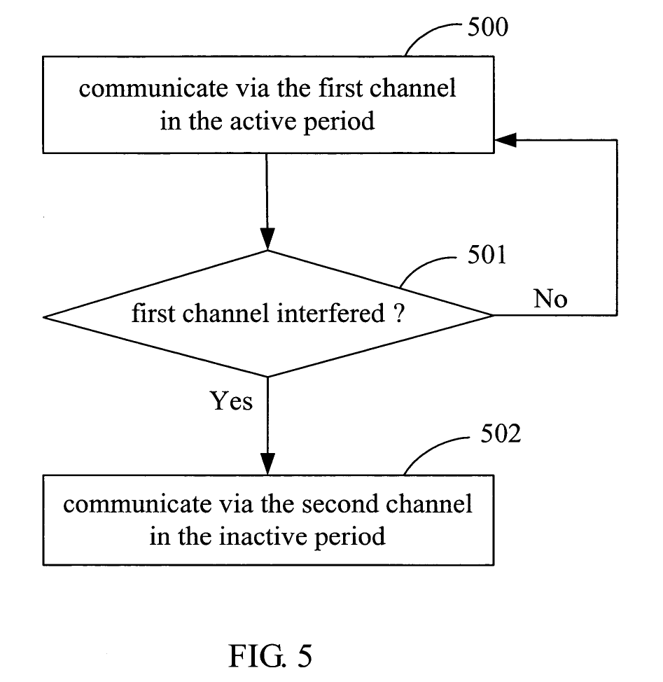

The third embodiment of the present invention is a communication method for a wireless communication system, as shown in FIG. 5. The wireless communication system communicates via a beacon. The beacon defines an active period and an inactive period. When step 500 is performing, it communicates via a first channel in the active period. Afterwards, step 501 is performed for determining whether the communication is affected by using the first channel. If so, it indicates that other channels are needed for the system to communicate. Thus, step 502 is performed for using a second channel in the inactive period to communicate. If not, it indicates that the first channel is useable for communication. Thus, the communication method goes back to step 500, and communicates via the first channel in the active period. After waiting a predetermined period of time, the communication method continues to perform step 501 for determining whether the communication is affected by using the first channel.

The communication method further determines whether an SOS signal is received when performing step 501. If so, it indicates that the first channel is interfered, then performs step 502. The step 501 could also determine whether it fails in communicating via the first channel for N times. If so, it indicates that the first channel is interfered.

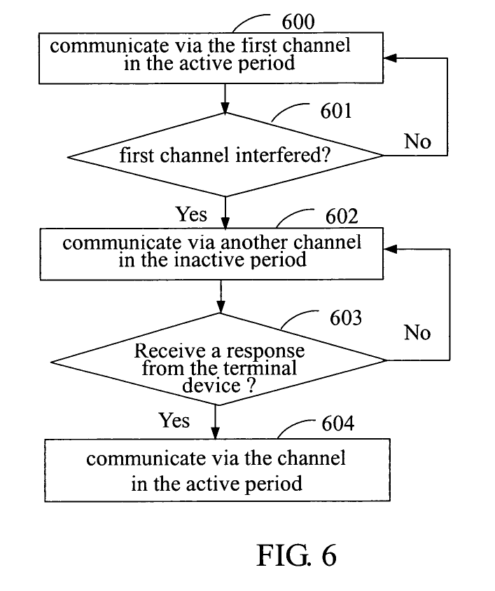

The fourth embodiment of the present invention is another communication method, as shown in FIG. 6. When step 600 is performing, it communicates via a first channel in an active period. Afterwards, step 601 is performed for determining whether the communication is affected by using the first channel. If so, performs step 602 for using another channel, such as a second channel, in the inactive period to communicate. It is different from the third embodiment that when step 603 is performed after step 602, it determines whether receives a response for availability of the second channel. If so, it indicates that the second channel is available for communication without influence from an interference source. Then, step 604 is performed for alternatively communicating via the second channel in the active period and data transmission in the inactive period is stopped. If not, it indicates that the second channel is also affected by the interference source. Thus, it goes back to step 602 for communicating via another channel, such as a third channel, in the inactive period. Afterwards, it performs step 603. If the third channel is still interfered, it chooses another channel, such as a fourth channel, in step 602 until the chosen channel is not interfered.

The methods described above could enable the selection and distribution device and/or the terminal device to perform the steps in FIG. 5 or FIG. 6 by using a computer readable medium being stored a computer program. The computer readable medium could be floppy disks, hard disks, CD-ROMs, portable storing devices, magnetic tapes, accessible database via network or any other storage media possessing the same functions that people skilled in the art could easily think of.

The first, second, third and fourth channels of the present specification merely individually indicate different channels but the number of the channels in the present invention is not limited.

Based on the above descriptions, the application of the present invention to the wireless network environment does not need to have extra elements. It could maintain the communication between the selection and distribution device and the terminal device even under interferences. By merely adjusting channels for those interfered devices, it has the advantages of costs reduction, broadly application under different kinds of interferences, and energy saving.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless communication system for communicating via a beacon, the beacon defining an active period and an inactive period, the wireless communication system comprising:
a terminal device; and
a selection and distribution device for initially using a first channel in the active period to communicate with the terminal device;
wherein the selection and distribution device communicates with the terminal device by using a second channel in the inactive period if the first channel is interfered.

2. The wireless communication system as claimed in claim 1, wherein the selection and distribution device uses the second channel in the active period to communicate if the terminal device responds availability of the second channel.

3. The wireless communication system as claimed in claim 1, wherein the selection and distribution device determines that the first channel is interfered when receiving an SOS signal from the terminal device.

4. A communication method adapted for a wireless communication system, the wireless communication system communicating via a beacon, the beacon defining an active period and an inactive period, the communication method comprising the steps of:
(a) using a first channel in the active period to communicate;
(b) determining whether the first channel is interfered, if yes, going to step (c); and
(c) using a second channel in the inactive period to communicate.

5. The communication method as claimed in claim 4, further comprising the steps of:
(d) determining whether to receive a response for availability of the second channel, if yes, going to step (e); and
(e) using the second channel in the active period to communicate.

6. A computer readable medium storing a computer program to perform a communication method for a wireless communication system, the wireless communication system communicating via a beacon, the beacon defining an active period and an inactive period, the communication method comprising the steps of:
(a) using a first channel in the active period to communicate;
(b) determining whether the first channel is interfered, if yes, going to step (c); and
(c) using a second channel in the inactive period to communicate.

7. The computer readable medium as claimed in claim 6, wherein the communication method further comprises the steps of:
(d) determining whether to receive a response for availability of the second channel, if yes, going to step (e); and
(e) using the second channel in the active period to communicate.
